(19) United States
(12) Patent Application Publication
(10) Pub. No.: US 2014/0342054 A1
(43) Pub. Date: Nov. 20, 2014

(54) QUERCETIN FOR BROWNING FOOD SURFACES

(71) Applicants: Sandrine Cavin, Epalinges (CH); Karlheinz Bortlik, Syens (CH); Martin Michel, Lausanne (CH)

(72) Inventors: Sandrine Cavin, Epalinges (CH); Karlheinz Bortlik, Syens (CH); Martin Michel, Lausanne (CH)

(73) Assignee: Nestec S.A., Vevey (CH)

(21) Appl. No.: 14/344,767

(22) PCT Filed: Aug. 17, 2012
(86) PCT No.: PCT/EP12/66116

§ 371 Date: Mar. 13, 2014

Related U.S. Application Data
(60) Provisional application No. 61/534,697, filed on Sep. 14, 2011.
(60) Provisional application No. 61/558,510, filed on Nov. 11, 2011.

(30) Foreign Application Priority Data
Sep. 13, 2011 (EP) 11181082.6
Nov. 11, 2011 (EP) 11188817.8

(51) Int. Cl. A23L 1/27; A21D 8/02

(52) U.S. Cl. CPC A23L 1/27; A21D 8/02
USPC 426/100; 426/103; 426/268

(57) ABSTRACT

The present invention relates to a food product with a colorless coating on a surface, said coating comprising a quercetin derivative or an either thereof. A further embodiment of the invention relates to a method for coloring a surface of a food product when heated, particularly when heated in a microwave over.

The present invention relates to a food product with a colorless coating on a surface, said coating comprising a quercetin derivative or an ether thereof. A further embodiment of the invention relates to a method for coloring a surface of a food product when heated, particularly when heated in a microwave oven.

The usage of microwave ovens in homes has increased significantly in recent years and continues to increase. While microwave cooking of foods affords a significant time saving over conventional oven cooking, it suffers from the disadvantage that food products cooked by microwave energy lack the desired degree of surface browning, that particularly those have that have a crust, such as pies, pizzas, bread, dough's etc. have when cooked in a conventional oven.

The most common reaction responsible for surface browning during cooking of products having a dough crust is the well-known Maillard reaction (i.e. non-enzymatic browning). This reaction occurs between naturally occurring reducing sugars and compounds containing an amino group, e.g. amino acids, peptides and proteins, and results in the formation of colored melanoidins. The rate at which the Maillard reaction proceeds to form such colored pigments increases significantly with temperature and time. When foods containing a dough crust, such as for example a frozen pizza, a bread or a snack, are heated in a conventional oven, the crust is heated to considerably higher temperatures than the interior of the food product, with the high surface temperatures being sufficient to achieve the desired browning.

However, in microwave heating the heat energy is released internally within the food product so that the surface remains at a relatively even temperature with the interior. There is a lack of hot, dry air surrounding the food product during microwave cooking. In addition, the food is usually cooked for a much shorter time. Consequently, the high surface temperatures necessary to achieve browning are not reached within the time required to bake the food product. The surface of the product remains moist and pale: the desired development of a nice brown surface color does not appear. The end-product, although well cooked, is often perceived as under-cooked by the consumer.

A number of compositions have been proposed to create a desirable browned surface of a food product when heated by microwave energy. Such prior microwave browning compositions typically are based on the Maillard reaction to effect browning, and include one or more components which permit the reaction to take place at lower temperatures or which increase the reaction rate. Such compositions typically include carbohydrates such as for example dextrose, maltodextrin and acetaldehyde compounds which result from pyrolysis of some of the sugar compounds prior to constitution of the browning composition (see U.S. Pat. No. 5,756,140). However, none of these prior compositions have been entirely satisfactory due to flavor concerns, the limitation of achievable color variations on a food product, and costs. Further, the presence of acetaldehydes and potentially still other compounds from the pyrolysis process may be perceived as less natural by consumers.

EPO481249 proposes a method to use an amount of water soluble tea solids applied to a food surface to develop a browned surface on the crust of such a food when heated by microwave energy. The shortcoming of the proposed method is that food products treated with such soluble tea solids retain a distinct flavor and taste of black tea. For most product applications, this is clearly not desired. It is believed that this significant flavor impact is due to the fact that a relatively high concentration of tea solids is needed to be applied to the food surface in order to be effective for the development of a desired surface coloration. A further major inconvenience of the application is that the food surface remains moist and soft. Hence, this solution does not provide the consumer with the impression of a well-cooked product with a well-developed crust. Furthermore, such treated products may retain certain astringency as well as a certain level of caffeine which may not be desired by consumers, particularly by children.

Currently on the market and commercially used is “Liquid or powder Smoke” (Red Arrow Products Company LLC, Manitowoc, WI, USA). “Liquid or Powder Smoke” overcomes the currently missing solution for fast browning of food surfaces in microwave applications. However, “Liquid Smoke” may not be well perceived by consumers. It contains aldehydes which have to be labeled on the packaging of the food products. Currently, the EFSA (European Food Safety Authority) is investigating the safety of “Liquid Smoke” as a food flavoring agent.

Hence, there is a clear need in the art to replace these substances with natural, safe compositions which can effectively be used on food products for inducing coloration of food surfaces upon heating for example in a microwave oven. Further, these compositions should be odorless or at least not having a negative impact on the final flavor of such a treated food product.

The object of the present invention is to provide an improved solution for coloring surfaces of food products to be heated thereafter, for example in a microwave oven, and which overcomes at least some of the inconveniences described above.

The object of the present invention is achieved by the subject matter of the independent claims. The dependent claims further develop the idea of the present invention.

Accordingly, the present invention pertains to a food product with a colorless coating on a surface, said coating comprising a quercetin derivative according to the general formula:

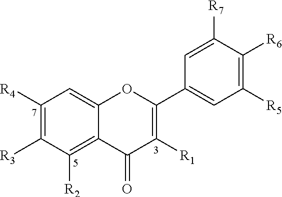

wherein R1 is OH or an O-glucoside; R2, R5 and R6 are OH; R3 and R7 are H; R4 is OH or an O-glucoside; or an ether of said quercetin derivative, the ether bond being formed at one of the hydroxyl groups of the quercetin derivative.

In a second aspect, the invention relates to a method for coloring a surface of a food product when heated, comprising the steps of i) coating the surface or a part thereof with a colorless coating comprising a quercetin derivative according to the general formula of claim 1 or an ether of said quercetin derivative, and ii) heating said product in order to develop a color of the surface.

The inventors surprisingly found that appealing yellow-brownish colors develop on the surface of a food product during heating, particularly during heating in a microwave oven, if such surface has been coated with a composition comprising a quercetin derivative or an ether of said quercetin derivative prior to the heating step. Such a composition can be a solution of a quercetin derivative or an ether thereof, or an extract from a natural source, such as from a plant material, comprising said quercetin derivative or ether. When combining such a surface coating further with a chemical base such as a sodium bicarbonate or sodium hydroxide solution, the appearance of the yellow-brownish color can be even more intensified and give raise to interesting new color variations within the brown range of the color spectrum.

This finding can now advantageously be applied to coat un- or prebaked food products with a transparent and nearly colorless surface coating, which upon baking in for example a microwave oven will develop a yellow-brown color of the food crust. It is of great advantage that the use of quercetin derivatives and ethers thereof is a natural solution and that there are no safety concerns to consumers. Furthermore, products coated with a quercetin derivative or ether thereof do not have and develop any negatively perceived flavors or odors either before or after heat treatment. A further advantage is that quercetin derivatives or its ethers, with or without the chemical base, can be applied easily in appropriate concentrations to such food surfaces without leading to moist and soft surfaces.

Furthermore, the inventors have found that the invention for coloration of a food product surface in a microwave oven works particularly well, if the food product before the heating in the oven is in a frozen state and/or if the quercetin derivatives or its ethers are applied first and separately from the chemical base onto said surface. Best results, however, are achieved by applying quercetin derivatives or its ethers first in a first coating onto the surface of the frozen food product and thereafter in a second step applying the chemical base to said coating of the still frozen food product in a second separate layer. It has been found by the inventors that the frozen state of the food product as well as the separate application of the quercetin derivatives or its ethers from the chemical base help to further slow down the color reaction at the food surface before the heating step e.g. during long term storage of the such treated food product. It is thereby possible to make food products with a quasi invisible colorless coating and which can be stored for an extended period of time with maintaining this coating invisible, which when heated in a microwave oven develop very nice and appetizing brown surface colors.

### BRIEF DESCRIPTION OF THE DRAWINGS

FIG. 1: Browning reaction of a quercetin-3-β-D-glucoside comprising surface coating on dough samples before and after heating in a microwave oven.

FIG. 2: Browning reaction of a quercetin comprising surface coating on dough samples treated with or without different chemical bases before and after heating in a microwave oven.

### DETAILED DESCRIPTION OF THE INVENTION

The present invention pertains to a food product with a colorless coating on a surface, said coating comprising a quercetin derivative according to claim 1 or an ether of said quercetin derivative.

Thereby, a “colorless coating” is understood as a coating on a food product surface which is transparent and without color. Hence, the colorless coating does not provide an own, proper color to the food product surface. A consumer looking at a food product with such a defined surface coating will not perceive a color coming from the coating per se.

The product of the invention can be coated on just one or several surfaces, if available. Preferably, the surface selected for the coating is the exterior face or part of the exterior face of the product which is visible upon presentation of the food product to a consumer.

The food product according of the invention pertains also to such products, wherein the surface is only partly coated with a quercetin derivative or an ether thereof. Partly meaning a part of the entire product surface is coated or treated with the quercetin derivative or its ether. This allows inducing a colored surface of only certain parts of a food product, to apply for example certain designs or figures which only appear in color after heating or baking of the product. Further, pictures or short texts could be produced on food surfaces in the same way as well.

In an embodiment, the O-glucoside of either the R1 and/or R4 of the general formula is a monosaccharide or a disaccharide of moieties selected from glucose, galactose, rhamnose or xylose. The advantage is that such quercetin derivatives occur naturally and can be found in various fruits and vegetables. Furthermore, such low molecular weight molecules are easier for handling and surface coating applications and tend to have a less intrinsic color of their own, which makes the application of the current invention more feasible.

Preferably, the quercetin derivative is selected from the group consisting of quercetin, izoquercetin, quercitrin, rutin, quercetin-7-O-glucoside and quercetin-3-O-rhamnoside-7-O-glucoside. Those quercetin derivatives are all natural compounds found in various different fruits and vegetables. They are safe for human consumption and well characterized in the scientific literature.

The ether of the quercetin derivative is selected from the group consisting of azaleatin, rhamnetin, isohramnetin and tamarixetin. Those compounds are ethers formed between at least one of the hydroxyl groups of the quercetin derivative molecule and an alcohol molecule, mostly a methanol. Such quercetin ethers are frequently found in nature and were for example identified in sage.

In one of the embodiments, the quercetin derivative or the ether of said quercetin derivative is derived from an extract of a plant material.

Quercetin, its derivatives and ethers naturally occur in many plant materials. It is of an advantage that extracts from such plants, for example from their fruits, leaves or roots, can be used as a natural source. Thereby, the said derivatives and ethers could be extracted and purified from those plant materials. Alternatively, the extracts themselves or just partly purified from those sources could be used. For the latter case, the product would have a much better acceptance with consumers as they would be considered more ‘natural’. Furthermore, production costs would be significantly lower than if the compounds would have to be produced synthetically or to be purified to homogeneity.

Preferably, the extract is from the plant material selected from the group consisting of mango fruit, plum, beans, onion, buckwheat, chicory and pepper, or a combination thereof. Those plants are all rich in either one of the quercetin derivatives and/or an ether thereof, and the plant materials are well accepted by consumers as well recognized food products themselves. Hence, they are food grade and safe to consume.

The quercetin derivatives and ethers of the invention further may comprise optionally a binder or thickener as for example pectin, xanthan, agar, dextrin, a gum adhesive agent or another food-grade hydrocolloid, in order to facilitate the technical applicability of the product to a food surface.

In a further embodiment, the amount of the quercetin derivative or the ether of said quercetin derivative on the surface of said product is in the range from 0.001-1.0 mg/cm², preferably from 0.005-0.5 mg/cm², more preferably from 0.01-0.1 mg/cm². These concentrations of the extract on the surface allow on one hand to provide a practically colorless food product surface coating before the baking or heating step, and on the other hand allow the food surface to develop a sufficiently satisfying color appearance after the heating in for example a microwave oven.

The food product of the present invention is further coated with a solution comprising a chemical base applied to said surface together with or separately of the quercetin derivative or the ether thereof. Thereby, the chemical base can be directly mixed into the solution or extract comprising the quercetin derivative or the ether thereof, and the pH of the originally acidic extract can be adjusted to a pH value between pH 7 and pH 8.5, for example. Alternatively, the chemical base can be applied separately to the surface either before or after applying the quercetin derivative or its ether, for example by spraying it directly onto said surface. As chemical base for example a solution of sodium bicarbonate such as conventional baking soda, sodium hydroxide or L-arginine can be applied.

The use of a chemical base together with the quercetin derivative or its ether has the advantage of accelerating the development of the desired color reaction. Thereby, the color appearance develops faster and more intense upon heating of the product surface. Further, using a developer such as a chemical base allows reducing the amount of quercetin derivative or its ether necessary for reaching the desired food coloring after the heating step. Hence, the objective to provide an as colorless food surface before heating and a well colored surface after heating can be achieved in this way.

In a preferred embodiment, the surface coating of the food product of the invention comprises less than 10⁻⁵ mMol/cm², preferably less than 10⁻⁶ mMol/cm², even more preferably less than 10⁻⁷ mMol/cm² ions of a transition metal, particularly of manganese and/or zinc ions. The advantage of having no or only a very limited amount of metal ions in the food product surface coating is to prevent possible off-tastes of the food product as well as a loss of quality due to the presence of such metal ions. Metal ions are known to have some off-taste and to enhance oxidation of certain compounds found in foods such as for example lipids. Hence, the presence of metal ions may lead to a faster loss of the food product quality as well as to negative organoleptic impacts due to undesired oxidation reactions.

In an alternative preferred embodiment, the food product of the invention is further coated with an ion of a transition metal, wherein the amount of the ion of a transition metal on the surface of said product is in the range from 0.00001-1.0 mg/cm², preferably from 0.0001-0.1 mg/cm², more preferably from 0.001-0.05 mg/cm².

It has been observed that the presence of transition metal ions together with a quercetin derivative or its ether has a synergistic effect in further and faster developing the color reaction at a food surface. Hence, in selecting appropriate concentrations of transition metal ions in combination with the quercetin derivative or its ether, the intensity and speed of the surface color development can be modified and optimized according to individual specific food applications and preferences.

The metal ions are of a transition metal, wherein the transition metal is selected from the group consisting of Fe, Mn, Co, Cr, Zn and Cu, or a combination thereof. Preferably, the transition metal is selected from the group consisting of Zn, Fe, Cu and Mn, or a combination thereof. Different metal ions react differently together with quercetin derivatives or its ethers, resulting in slightly but distinct different color appearances within the brownish range of the color spectrum. This again allows adapting not only color intensity but also the color per se for an individualized use of the invention according to the desired product application.

The food product of the invention is to be heated, and particularly so, the surface of said food product is to be heated. Typically, such heating can be achieved in a conventional oven or by any other means of heating a product or its surface such as for example by exposing the product to a heating lamp or an infrared heater. Preferably, the product of the invention is heated in a microwave oven.

It is mainly for food products intended to be heated for a short time only and at relative lower surface temperatures that the invention provides a good solution to surface coloring. Hence, the invention is advantageously applied on food products intended for being heated in a microwave oven. For example, food products of the present invention are heated for at least 2 min at 250 Watts or higher, preferably for at least 4 min at said Watts in a microwave oven. Alternatively, the food products are heated for 1 min and 20 seconds or longer in a microwave oven at 600 Watts or higher.

The food product according to the invention mainly pertains, but is not limited, to products selected from the group consisting of dough, bread, cookies, cereals, bakery products, pizzas, snacks, gratins, cooked pasta, lasagne, cheese and rice dishes, and meat.

Preferably, the food product is a frozen food product before being heated e.g. in a microwave oven. For example, the product is a frozen pizza; a frozen dough or bread product such as a Panini or Hot Pocket product; a frozen gratin, pasta, lasagna, cheese or rice dish.

The advantage of the invention for an application to a frozen food product is that the colorless coating is more stable and remains quasi invisible for a long period of storage, before developing the desired brown surface color upon the heating step, e.g. in a microwave oven.

A further aspect of the invention is a method for coloring a surface of a food product when heated, comprising the steps of i) coating the surface or a part thereof with a colorless coating comprising a quercetin derivative according to claim 1 or an ether of said quercetin derivative, and ii) heating said product in order to develop a color of the surface.

The method of the invention comprises in a further embodiment the step of applying to said surface a solution comprising a chemical base before heating the product. The step of applying the chemical base to the surface can be combined with applying the quercetin derivative or its ether by for example providing both compositions in a same solution or extract and applying them together to the surface. However, the application to the surface can also be provided separately, by for example first applying the chemical base solution and thereafter the quercetin derivative or ether solution, or vice versa. However, both have to be applied to the product surface before the heating step. To separate the individual steps as out-lined above has the advantage that it allows to separate the reactants to better control the coloring reaction. As a chemical base for example a solution of sodium bicarbonate, sodium hydroxide or L-arginine can be used.

In a still further embodiment, the colorless coating comprises the quercetin derivative or the ether of said quercetin derivative in encapsulated form. A further embodiment is that the chemical base is encapsulated. A still further possibility is that both, the quercetin derivative or its ether as well as the chemical base are encapsulated separately.

Encapsulation technology is well known in the art and could be applied here to either the quercetin compounds and/or the chemical base. Condition is that the encapsulation releases its enclosed substances once heated above a critical temperature. Advantageously, the two components, the quercetin compounds and the chemical base, would not interact and react with each other while being encapsulated and present at the same time in the surface coating of a finished food product before the heating step. Upon heating, however, the components would be released from their encapsulation and could start to react and interact with each other. This would allow on one hand to improve color stability for increasing storage and distribution time of such coated food products, and on the other hand the perceived effect of surface coloring during the heating step could be significantly increased.

A further particular embodiment is the method of the invention, further comprising the step of applying to the surface of a food product a solution comprising an ion of a transition metal before heating the product in order to develop a color of the surface. The ion of the transition metal may be encapsulated or not.

Advantageously, the method of the invention is used for products which are intended to be heated in a microwave oven, for example in-home by a consumer. Upon heating in the microwave oven, the product does then develop a brownish color at the surface, typically for a well baked and appetizing product. Such brownish colors depend with the application, the food product type, the concentration and choice of the different reactants and can result in a variety of different color aspects.

Further advantageously, the method of the invention is for a food product, wherein the food product is in a frozen state before being heated in order to develop a color of the surface. It has been found by the inventors that the method of the invention works particularly well for frozen food products as any pre-colorization of the treated surface of such a frozen product, e.g. during a period of storage, is minimal before the heating step in comparison to for example a same treated surface of a non-frozen food product.

In a preferred embodiment the heating of the product is in a microwave oven from 250 to 1400 Watts, preferably from 600 to 1100 Watts. Advantageously, the method of the invention is used for products which are intended to be heated in a microwave oven, for example in-home by a consumer. Upon heating in the microwave oven, the product would then develop a yellow-brownish color at the surface, typical of a well baked and appetizing product. Such brownish colors depend with the application, food product type, the concentration and choice of the different reactants and can result in a variety of color aspects, reaching into orange, golden-yellow and brown.

Those skilled in the art will understand that they can freely combine all features of the present invention disclosed herein. In particular, features described for the product of the present invention may be combined with the method of the present invention and vice versa. Further, features described for different embodiments of the present invention may be combined.

Further advantages and features of the present invention are apparent from the figure and examples.

### EXAMPLE 1

50 g of pectin (Pectin Classic CU 401, Herbstreith & Fox KG, Germany) was dissolved in 2′000 g of de-mineralized water, heated at 60° C. for 1 hour and the pH adjusted with NaOH to pH 4.5. A 0.1 wt % solution of Quercetin 3-β-D-Glucoside (from Fluka, Switzerland) was prepared by dissolving 10 mg of Quercetin 3-β-D-Glucoside in a final 10 mL of the above pectin solution. Subsequently, about 0.45 g of the resulting Quercetin solution was brushed onto the cookie raw dough surface covering about 33.2 cm² (circle having a diameter of 6.5 cm), which corresponds to a concentration of Quercetin 3-β-D-Glucoside of about 0.014 mg/cm² at the cookie dough surface. The cookie doughs were then cooked for 1 min 20 sec in a microwave oven (NN-255 Panasonic) at 600 Watts.

An additional set of experiments was carried out following the same procedure as described above. However, after application of the Quercetin 3-β-D-Glucoside solution to the dough surfaces, about 0.2 g of a 1M solution of baking soda in water was sprayed onto the same dough surfaces before cooking in the microwave oven under the same conditions as above.

The color analysis was carried out using the CIELab* notation. In the International Commission on Illumination (CIE), a color is represented by a point in a color space. The coordinates of such a point are: the luminosity L (L=0: black, L=100: white), a* the amount of red and green (a* positive: red, a* negative: green), and b* the amount of yellow and blue (b* positive: yellow, b* negative: blue). The Color analysis was registered using a computer controlled digital camera system (DigiEye, Verivide) with a D65 light source.

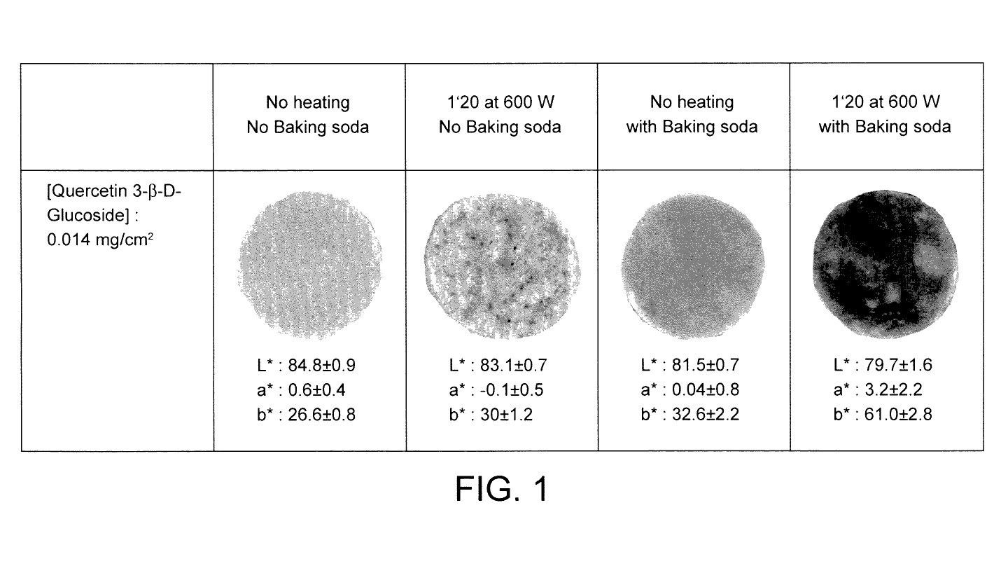

The results are shown in FIG. 1. The heating step induced a decrease of the L* (luminosity) value and an increase of the b* (blue to yellow) value which indicates that the color of the cookie surface turned towards the yellow color. This change was even more pronounced when baking soda was added.

### EXAMPLE 2

About 0.45 g of a 0.1 wt % Quercetin-pectin solution was brushed onto the surface of a round LEISI pastry dough covering about 44.2 cm² (circle having a diameter of 7.5 cm), which corresponds to a concentration of Quercetin of about 0.011 mg/cm² at the cookie dough surface. The dough pastries were then cooked for 1 min 20 sec in a microwave oven (NN-255 Panasonic) at 600 Watts.

An additional set of experiments was carried out following the same procedure as described above. However, after application of the Quercetin-pectin solution to the dough surfaces, about 0.3 g of a a) sodium hydroxide solution 0.1 M, b) sodium hydroxide solution 1 M , c) sodium bicarbonate 1M, d)L-histidine 0.2 M and e) L-arginine 0.44 M was sprayed onto the same dough surfaces before microwaving under the same conditions as above.

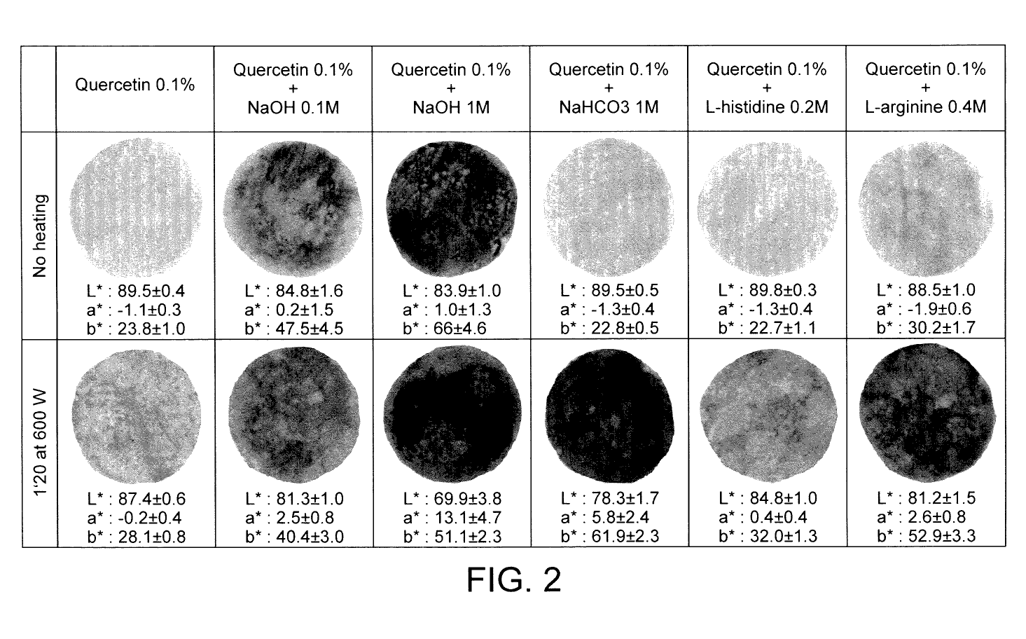

The results are shown in FIG. 2. The heating step induced a decrease of the L* value (Luminosity), the overall colour became darker. The colour is not only becoming darker during baking, but the overall colour change depending on the chemical base used. With the sodium hydroxide as chemical base, the general colour is less yellow and redder, with the sodium bicarbonate the colour goes from transparent to yellow as well as with the L-arginine. L-arginine has a pKa value of ca. 12.5 and hence acts here as a food-grade chemical base. L-histidine, with a pKa value of ca. 6.0, only has a limited impact on the surface pH which has been adjusted in the pectin solution to pH 4.5. Hence, the result of the L-histidine on intensifying the coloration effect of the quercetin is only small.

1. A food product with a colorless coating on a surface, the coating comprising a quercetin derivative according to the general formula: 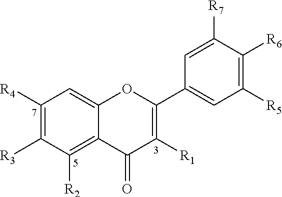
wherein
R1 is OH or an O-glucoside;
R2, R5 and R6 are OH;
R3 and R7 are H;
R4 is OH or an O-glucoside;
or an ether of the quercetin derivative, the ether bond being formed at one of the hydroxyl groups of the quercetin derivative.

2. The product of claim 1, wherein the O-glucoside is a monosaccharide or a disaccharide of moieties selected from the group consisting of glucose, galactose, rhamnose and xylose.

3. The product of claim 1, wherein the quercetin derivative is selected from the group consisting of quercetin, izoquercetin, quercitrin, rutin, quercetin-7-O-glucoside and quercetin-3-O-rhamnoside-7-O-glucoside.

4. The product of claim 1, wherein the ether of the quercetin derivative is selected from the group consisting of azaleatin, rhamnetin, isohramnetin and tamarixetin.

5. The product of claim 1, wherein the quercetin derivative or the ether of the quercetin derivative is derived from an extract of a plant material.

6. The product of claim 5, wherein the plant material is selected from the group consisting of mango fruit, beans, onion, buckwheat, chicory, pepper, and a combination thereof.

7. The product of claim 1, wherein the amount of the quercetin derivative or the ether of the quercetin derivative on the surface of the product is from 0.001-1.0 mg/cm².

8. The product of claim 1, wherein the coating of the surface of the product comprises a chemical base.

9. The product of claim 8, wherein the chemical base is selected from the group consisting of sodium bicarbonate, sodium hydroxide, L-arginine, and a combination thereof.

10. The product of claim 1, wherein the product is a frozen food product.

11. The product of claim 1, wherein the product is selected from the group consisting of dough, bread, cookies, cereals, pizzas, snacks, gratins, cooked pasta, lasagna, cheese and rice dishes.

12. A method for coloring a surface of a food product when heated, comprising the steps of: coating the surface or a part thereof with a colorless coating comprising a quercetin derivative according to the general formula: 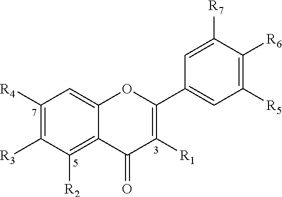
wherein
R1 is OH or an O-glucoside;
R2, R5 and R6 are OH;
R3 and R7 are H;
R4 is OH or an O-glucoside;
or an ether of the quercetin derivative, the ether bond being formed at one of the hydroxyl groups of the quercetin derivative or an ether of the quercetin derivative; and heating the product in order to develop a color of the surface.

13. The method of claim 12, comprising the step of applying to the surface a solution comprising a chemical base before heating the product.

14. The method of claim 12, comprising the step of applying to the surface a solution comprising an ion of a transition metal before heating the product.

15. The method of claim 12, wherein the quercetin derivative or the ether of the quercetin derivative is encapsulated and/or the chemical base is encapsulated and/or the ion of the transition metal is encapsulated.
